(19) United States
(12) Patent Application Publication
(10) Pub. No.: US 2023/0161661 A1
(43) Pub. Date: May 25, 2023

(54) UTILIZING TOPOLOGY-CENTRIC MONITORING TO MODEL A SYSTEM AND CORRELATE LOW LEVEL SYSTEM ANOMALIES AND HIGH LEVEL SYSTEM IMPACTS

(71) Applicant: Accenture Global Solutions Limited, Dublin (IE)

(72) Inventors: Luke HIGGINS, West Pymble (AU); Charles GRENET, Antony (FR); Koushik M. VIJAYARAGHAVAN, Chennai (IN); Aditi KULKARNI, Bangalore (IN); Jeremy Owen SMITH, Queenscliff (AU); David Marinus Morris IRELAND, Cremorne (AU); Campbell Kai WANG, Artarmon (AU); Rajendra PRASAD TANNIRU, Basking Ridge, NJ (US)

(21) Appl. No.: 17/456,056

(22) Filed: Nov. 22, 2021

(51) Int. Cl. G06F 11/07; G06N 20/00

(52) U.S. Cl. CPC G06F 11/079; G06F 11/0769; G06N 20/00

(57) ABSTRACT

A device may receive input data identifying metrics associated with components of a system, and may format the input data to generate formatted input data. The device may utilize the formatted input data to generate a topology of the system, and may customize models of nodes of the topology, based on the formatted input data, to generate a customized topology with customized nodes. The device may generate aggregation rules for aggregating anomalies, generated by the customized topology, and may aggregate the anomalies generated by the customized topology, into events, based on the aggregation rules. The device may process the events, with a machine learning model, to generate clustered events from the events, and may configure alerting rules associated with alerting actions, based on the clustered events, to generate configured alerting rules. The device may perform one or more actions based on the clustered events and the configured alerting rules.

### BACKGROUND

A system, such as an information technology system, may include an information system, a communications system, a computer system, and/or the like. The system may include a network of devices, applications, hardware, software, peripheral equipment, and/or the like operated by a group of users.

### SUMMARY

Some implementations described herein relate to a method. The method may include receiving input data identifying metrics associated with components of a system, and formatting the input data to generate formatted input data. The method may include storing the formatted input data in indexes, and utilizing the formatted input data of the indexes to generate a topology of the system, where the topology includes nodes and connectors, and where each node includes a model that processes corresponding formatted input data. The method may include customizing the models of the nodes of the topology, based on the formatted input data, to generate a customized topology with customized nodes, and generating aggregation rules for aggregating anomalies generated by the customized topology. The method may include aggregating the anomalies generated by the customized topology, into events, based on the aggregation rules, and processing the events, with a machine learning model, to generate clustered events from the events. The method may include configuring alerting rules associated with alerting actions, based on the clustered events, to generate configured alerting rules, and performing one or more actions based on the clustered events and the configured alerting rules.

Some implementations described herein relate to a device. The device may include one or more memories and one or more processors coupled to the one or more memories. The one or more processors may be configured to cause a global data transform to execute across multiple data sources and to transform the multiple data sources into a single homogenous data source, and receive, from the single homogeneous data source, input data identifying metrics associated with components of a system. The one or more processors may be configured to format the input data to generate formatted input data, and store the formatted input data in a data structure. The one or more processors may be configured to utilize the formatted input data of the data structure to generate a topology of the system, and customize the models of the nodes of the topology, based on the formatted input data, to generate a customized topology with customized nodes. The one or more processors may be configured to generate aggregation rules for aggregating anomalies generated by the customized topology, and aggregate the anomalies generated by the customized topology, into events, based on the aggregation rules. The one or more processors may be configured to process the events, with a machine learning model, to generate clustered events from the events, and configure alerting rules associated with alerting actions, based on the clustered events, to generate configured alerting rules. The one or more processors may be configured to perform one or more actions based on the clustered events and the configured alerting rules.

Some implementations described herein relate to a non-transitory computer-readable medium that stores a set of instructions for a device. The set of instructions, when executed by one or more processors of the device, may cause the device to receive input data identifying metrics associated with components of a system, and format the input data to generate formatted input data. The set of instructions, when executed by one or more processors of the device, may cause the device to utilize the formatted input data to generate a topology of the system, and customize models of nodes of the topology, based on the formatted input data, to generate a customized topology with customized nodes. The set of instructions, when executed by one or more processors of the device, may cause the device to generate aggregation rules for aggregating anomalies generated by the customized topology, and aggregate the anomalies generated by the customized topology, into events, based on the aggregation rules. The set of instructions, when executed by one or more processors of the device, may cause the device to process the events, with a machine learning model, to generate clustered events from the events, and configure alerting rules associated with alerting actions, based on the clustered events, to generate configured alerting rules. The set of instructions, when executed by one or more processors of the device, may cause the device to perform one or more actions based on the clustered events and the configured alerting rules.

### BRIEF DESCRIPTION OF THE DRAWINGS

FIGS. 1A-1G are diagrams of an example implementation described herein.

FIG. 2 is a diagram illustrating an example of training and using a machine learning model in connection with generating clustered events from event data.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing topology-centric monitoring to model a system and correlate low level system anomalies and high level system impacts.

### DETAILED DESCRIPTION

The following detailed description of example implementations refers to the accompanying drawings. The same reference numbers in different drawings may identify the same or similar elements.

As computing systems become more complex (e.g., with many vendors, integration points, microservices, and/or the like), monitoring and performing incident triage and root cause analysis for such systems becomes more complex. Current techniques for monitoring a system utilize several siloed monitoring systems and subject matter experts. This creates a lack of transparency between components of the system, and fails to provide high-level control to link the components together. Furthermore, initial remediation stages of the monitoring systems are slowed by uncertainty in a degree of impact of a failure and by which components of the system have caused the failure. Therefore, current techniques for monitoring a system consume computing resources (e.g., processing resources, memory resources, communication resources, and/or the like), networking resources, and/or the like associated with failing to provide high level control of the system, failing to determine an impact of a system failure, coordinating various teams of personnel to monitor the system, losing business opportunities with a client due to a failing system, and/or the like.

Some implementations described herein relate to a monitoring system that utilizes topology-centric monitoring to model a system and correlate low level system anomalies and high level system impacts. For example, the monitoring system may receive input data identifying metrics associated with components of a system, and may format the input data to generate formatted input data. The monitoring system may store the formatted input data in indexes, and may utilize the formatted input data of the indexes to generate a topology of the system. The topology may include nodes and connectors, and each node may include a model that processes corresponding formatted input data. The monitoring system may customize the models of the nodes of the topology, based on the formatted input data, to generate a customized topology with customized nodes, and may generate aggregation rules for aggregating anomalies, generated by the customized topology. The monitoring system may aggregate the anomalies generated by the customized topology, into events, based on the aggregation rules, and may process the events, with a machine learning model, to generate clustered events from the events. The monitoring system may configure alerting rules associated with alerting actions, based on the clustered events, to generate configured alerting rules, and may perform one or more actions based on the clustered events and the configured alerting rules.

In this way, the monitoring system utilizes topology-centric monitoring to model a system and correlate low level system anomalies and high level system impacts. The monitoring system may monitor metric data of the system with multiple anomaly detection models, and may represent these metrics in multi-layered system networks. The monitoring system may correlate anomalies into events with network links and defined rules, and may trigger event alerting actions (e.g., alarms, tickets, emails, and/or the like) via rules and/or event clustering. The monitoring system may significantly reduce incident triage time, may resolve issues more quickly, and may reduce an impact of an incident. The incident triage time may be reduced due to the monitoring system identifying anomalies earlier and with higher accuracy, grouping anomalies in accordance with the defined rules, generating visualizations showing the anomalies, linking failures to material system impacts, and/or the like. This, in turn, conserves computing resources, networking resources, and/or the like that would otherwise have been consumed in failing to provide high level control of the system, failing to determine an impact of a system failure, coordinating various teams of personnel to monitor the system, losing business opportunities with a client due to a failing system, and/or the like.

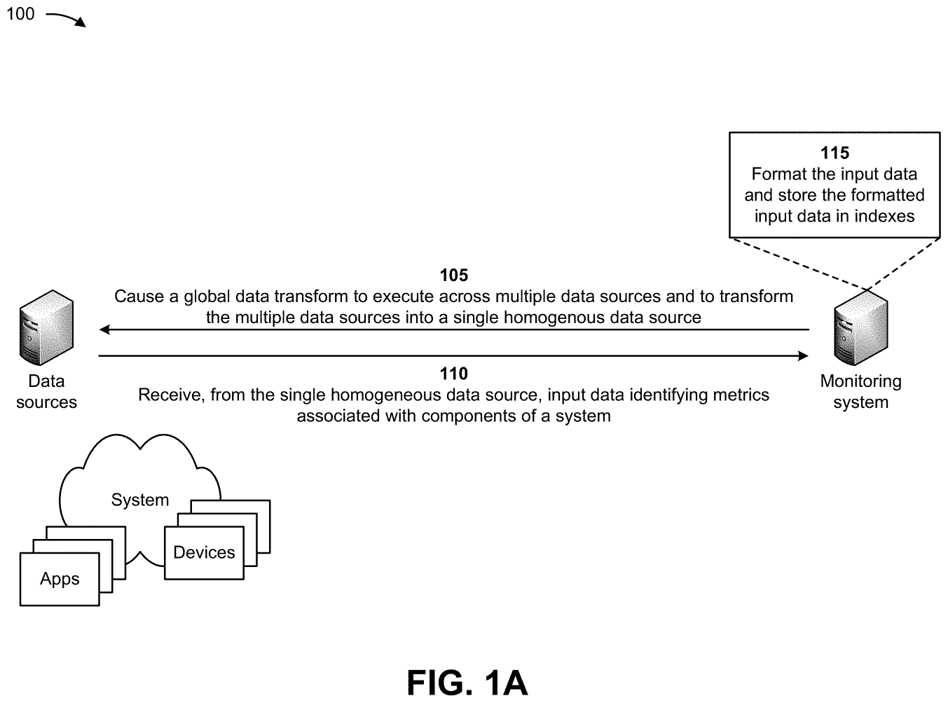

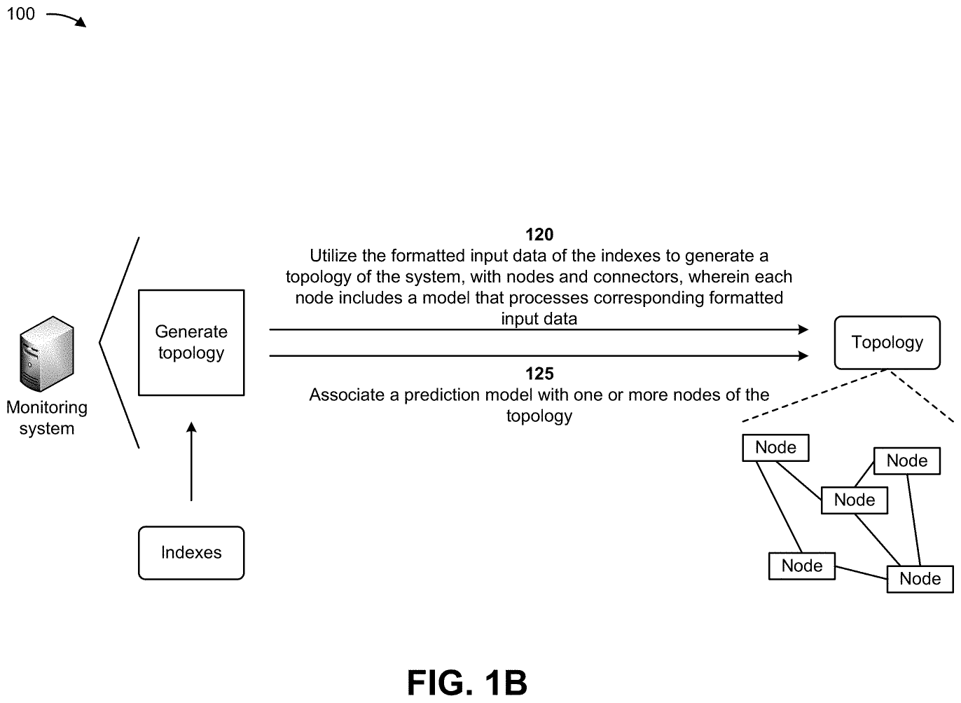

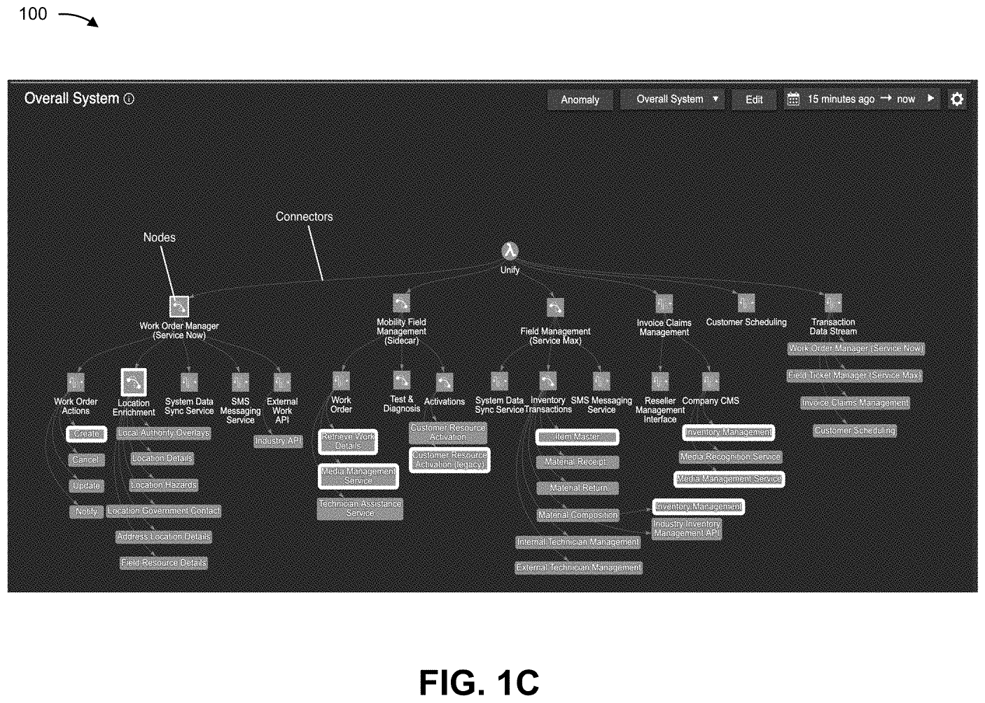

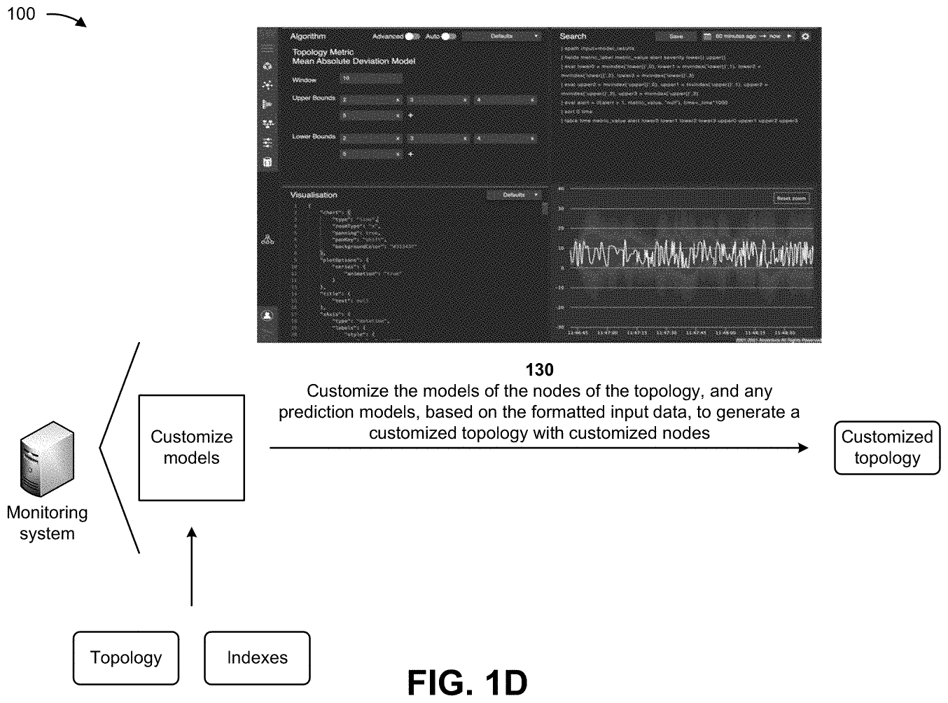

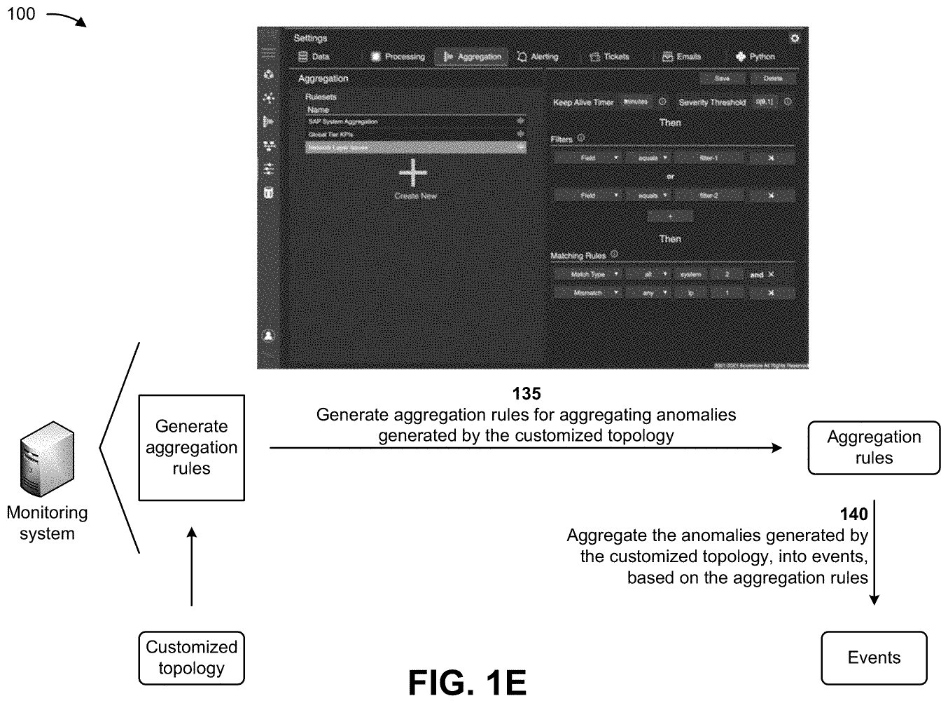

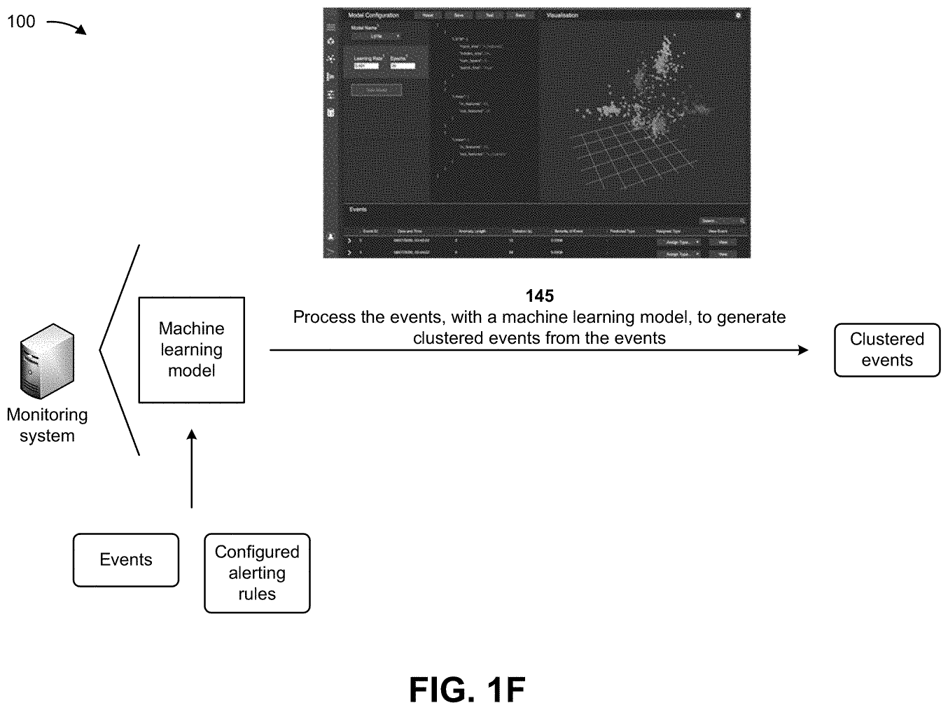

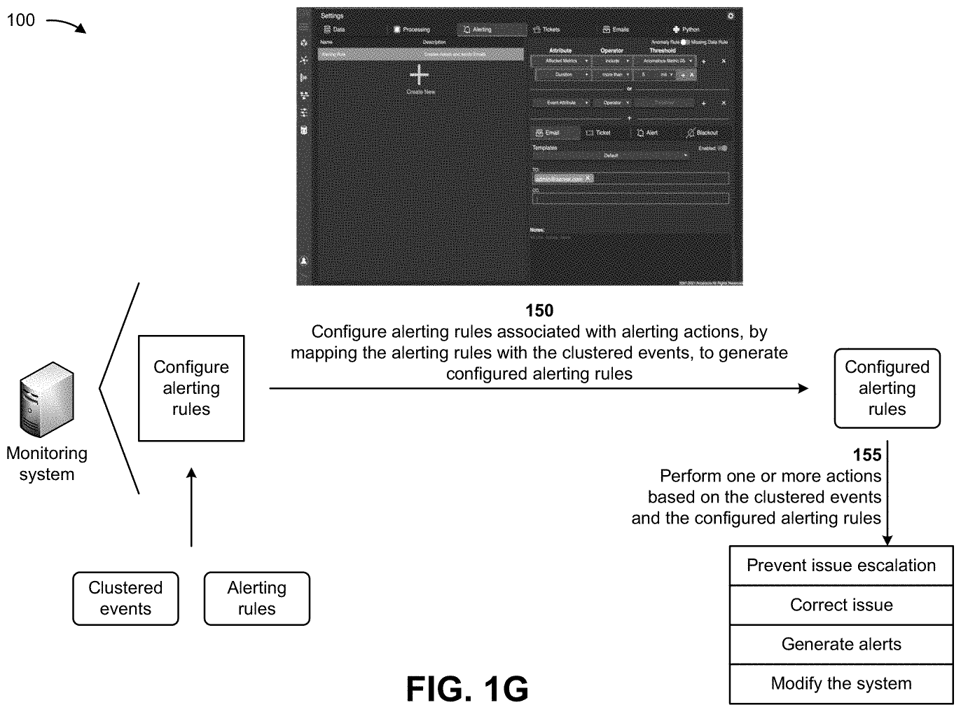

FIGS. 1A-1G are diagrams of an example 100 associated with utilizing topology-centric monitoring to model a system and correlate low level system anomalies and high level system impacts. As shown in FIGS. 1A-1G, example 100 includes data sources, a system, and a monitoring system. Each of the data sources may include an application server, a client server, a web server, a database server, a host server, a proxy server, a virtual server, or a server in a cloud computing system. The system may include an information system, a communications system, a computer system, and/or the like. The system may include a network of devices, applications, hardware, software, peripheral equipment, and/or the like operated by a group of users. The monitoring system may include a system that utilizes topology-centric monitoring to model a system and correlate low level system anomalies and high level system impacts. Further details of the data sources, the system, and the monitoring system are provided elsewhere herein.

As shown in FIG. 1A, and by reference number 105, the monitoring system may cause a global data transform to execute across the multiple data sources and to transform the multiple data sources into a single homogenous data source. For example, the monitoring system may generate a single global data transform to execute across the multiple data sources, and may cause the single global data transform to execute across the data sources. Execution of the global data transform across the multiple data sources may transform multiple data sources into a single homogenous data source in one step. In this way, the monitoring system may prevent data overload and overprocessing, at the monitoring system, caused by current non-functional monitoring platforms and monitoring applications. For example, current monitoring platforms and applications create the data overload and overprocessing by creating system metrics with individual pre-transforms.

As further shown in FIG. 1A, and by reference number 110, the monitoring system may receive, from the single homogeneous data source, input data identifying metrics associated with components of the system. For example, the monitoring system may continuously receive the input data from the data sources, may periodically receive the input data from the data sources, may receive input data from the data sources based on providing requests for the input data to the data sources, and/or the like. In some implementations, the monitoring system may continuously receive the input data from the single homogeneous data source, may periodically receive the input data from the single homogeneous data source, and/or the like. The metrics associated with the components of the system may include metrics associated with a network of the system, devices of the system, applications of the system, hardware of the system, software of the system, peripheral equipment of the system, application level data, user data, miscellaneous metrics, and/or the like.

As further shown in FIG. 1A, and by reference number 115, the monitoring system may format the input data and store the formatted input data in indexes. For example, when formatting the input data to generate the formatted input data, the monitoring system may extract the metrics from the input data, where the metrics correspond to the formatted input data. In some implementations, the monitoring system may utilize pre-transforms to process the multi-dimensional input data in any form and to extract out the metrics from the input data. The monitoring system may format the input data in a single stage, which significantly improves performance over the current monitoring platforms and applications. In some implementations, the monitoring system may format the input data to fit a first data type (e.g., raw data) or a second data type (e.g., alert data). The monitoring system may generate the indexes for the formatted input data in a data structure (e.g., a database, a table, a list, and/or the like) associated with the monitoring system. The monitoring system may store the formatted input data in the indexes based on whether the input data is the first data type or the second data type.

As shown in FIG. 1B, and by reference number 120, the monitoring system may utilize the formatted input data of the indexes to generate a topology of the system, with nodes and connectors, wherein each node includes a model that processes corresponding formatted input data. For example, after storing the formatted input data in the indexes, the monitoring system may retrieve the formatted input data from the indexes and may populate a system topology creation dashboard with the formatted input data. The monitoring system may create the topology of the system by creating nodes that represent the metrics of the formatted input data, linking connectors or edges between the nodes, adding background images, text, and other custom elements (e.g., arrows, boxes, highlights, and/or the like), and/or the like. The topology may include a digital twin of the system and the monitoring system may automatically populate the topology with the formatted input data. A digital twin is a virtual model that represents a physical object, such as a network node, a server, communications interface, and/or the like. The digital twin can be updated using data, such as real-time data, to ensure that the virtual representation of the physical object is accurate and up-to-date.

In some implementations, the monitoring system may create a key-value (KV) store to represent the topology and to store the nodes, edges, and other topology visualization elements. Each of the nodes of the topology may include a model that processes corresponding formatted input data. In some implementations, each of the nodes of the topology may include the model, a set of metrics to be processed by the model, and a user interface representation. In some implementations, the model of each node may include a static thresholding model, a mean absolute deviation model, a mean absolute difference model, a fast Fourier model, an average seasonal model, an independent trend model, a smart seasonal model, a long short-term memory (LSTM) model, and/or the like. The smart seasonal model may be automatically fit to seasonal data (e.g., a seasonal mean and deviation) with trend and lock seasonality to time of day. The smart seasonal model may address the inability of existing models to automatically detect and fit to traffic-based data. The existing models either require manual configuration or have poor auto-fit capability that generate false alerts.

In some implementations, some of the nodes may include high level, abstract nodes that represent user-friendly components of the system and that include a drilldown feature to depict an underlying performance (e.g., a customer satisfaction node with a complaint rate, a latency, or a watch time metric). A low level topology may include nodes more representative of the metrics (e.g., a processor usage node with processor usage metric). The higher-level nodes may require more complex models (e.g., modeling user traffic that is highly seasonal within a week and that has a moderate trend for growing/shrinking user bases). As a result, the monitoring system may provide the wide range of models, described above, for the nodes. Each of the models may receive an array of metric labels as an input, may receive and store data from a specialized data structure (e.g., to prevent the models from utilizing data over large time ranges), may receive parameters in a standardized format, may output data in a specific format, and/or the like.

As further shown in FIG. 1B, and by reference number 125, the monitoring system may associate a prediction model with one or more nodes of the topology. For example, the monitoring system may determine whether a prediction model is required for each of the nodes based on the metrics associated with each of the nodes. If the monitoring system determines that a prediction model is required for a node, the monitoring system may fit the prediction model to the metrics associated with the node. In some implementations, the monitoring system may analyze the metrics associated with the node, and may determine which prediction model to utilize to track anomalies for the node. The prediction model may include a classification model, a clustering model, a forecast model, an outlier model, a time series model, and/or the like.

As shown in FIG. 1C, an example topology may include a plurality of nodes interconnected by a plurality of linking connectors. For example, the topology may include a node for work management, mobility field management, field management, payments, appointments, a pipeline, enrichment, work orders, test and diagnosis, activations, materials and supplies, and/or the like.

Current techniques enforce strict rules, such as inter-node relationships, not editable auto-discovered topologies, fixed metric to node relations, and/or the like. In contrast, the flexible topology creation of the monitoring system allows metrics and models to be created as nodes and connected in any way, allows arbitrary elements (e.g., background images, text and shapes) to be added, and allows topologies to be nested. The topology may represent user understanding of the system, which improves topology usability in root cause analysis, as users understand each component in the topology and the links. Additionally, topologies may be forwarded from databases, auto-discovery tools, or other applications to accelerate setup.

The flexible topology also eliminates the problems with bottom-up topologies. Bottom-up topologies move low level metrics to high level nodes through aggregations, with high level nodes being simple calculations of lower metrics. This causes false alarms and high-level nodes to not clearly indicate material business impacts. The top-down approach of the monitoring system specifies that each node, while linked to child nodes, may represent a metric to be monitored. High level nodes may directly map to business relevant metrics and may provide clear impacts of issues on the system. The ability to customize metrics behind nodes enables the monitoring system to create events that include high level business impacts with low-level root causes.

As shown in FIG. 1D, and by reference number 130, the monitoring system may customize the models of the nodes of the topology, and any prediction models, based on the formatted input data, to generate a customized topology with customized nodes. For example, once the topology is created and any desired prediction models are associated with nodes of the topology, the monitoring system may customize the models of the nodes of the topology. The monitoring system may customize the models by fitting the metrics to the models, defining quantities of data to process by the models, adjusting parameters of the models, defining bounds for the models, defining types of data to process by the models, and/or the like. In some implementations, by default, each of the nodes of the topology may include a preconfigured mean absolute deviation model. The monitoring system may replace the default model with another model (e.g., a static thresholding model, a mean absolute difference model, a fast Fourier model, an average seasonal model, an independent trend model, a smart seasonal model, an LSTM model, and/or the like) and may configure the other model. Customization of the models for the nodes may generate customized nodes and the customized nodes may constitute a customized topology of the system.

As shown in FIG. 1E, and by reference number 135, the monitoring system may generate aggregation rules for aggregating anomalies generated by the customized topology. For example, the system may continuously generate new input data that is received and formatted by the monitoring system to generate new formatted input data. The monitoring system may provide the new formatted input data to the customized topology to update outputs of the customized nodes of the customized topology, to generate new customized nodes for the customized topology, to modify or remove one or more customized nodes of the customized topology, and/or the like. In some implementations, the models of the customized nodes may process the new formatted input data to generate outputs. The outputs may indicate that corresponding components of the system are performing correctly, may identify anomalies indicating that corresponding components of the system are performing incorrectly, and/or the like.

In some implementations, the monitoring system may create the aggregation rules for aggregating the anomalies generated by the customized nodes of the customized topology (e.g., based on the new formatted input data). For each aggregation rule, the monitoring system may set a timer (e.g., a keep alive timer for the rule) and severity thresholds, may apply filters to include or exclude particular metrics, may define grouping parameters that divide or group metrics based on specified field values, and/or the like. The monitoring system may determine which anomalies to group together and may create the aggregation rules based on this determination. For example, the monitoring system may create an aggregation rule that aggregates the anomalies based on topologies associated with the anomalies, an aggregation rule that aggregates the anomalies based on sources of the anomalies, an aggregation rule that aggregates the anomalies based on time periods associated with the anomalies, an aggregation rule that aggregates the anomalies based on a smart topology correlation (e.g., via subject matter expert knowledge, auto-discovered topologies, a configuration management database, and/or the like).

With regard to smart topology correlation, whenever a node (and corresponding model) is added to a topology, the monitoring system may append a topology identifier to the topology tags of the model. The topology identifiers may identify models that belong to a same topology. This may correlate the models (and input metrics) together when aggregating the anomalies into the events. When an aggregation rule adds an anomaly to an event, tags of the anomaly may be added to the event tags. This may enable correlation within a single topology. If a model from multiple topologies is added to an event, the monitoring system may add the multiple topologies to the event. If topology-based aggregation rules are active, then anomalies from these other topologies may be grouped with the event. This is one method in which anomalies from multiple topologies can be correlated together (e.g., topologies are treated as siblings). Another method to automatically correlate anomalies from multiple topologies may be through parent-child topologies. When a particular quantity of models in a topology are anomalous, the entire topology may be in an anomalous state. Any parent topologies that include an anomalous child topology as a node may also have an anomaly generated. The generated anomaly may be tagged with both the child and parent topologies, and if grouped with an event, may also include the parent topology in the anomaly. The monitoring system may receive topologies from multiple sources (e.g., user created topologies, fixed topologies forwarded by auto-discovery tools or other applications, and topologies generated from databases). The flexible framework for correlating within a single topology and spreading correlation between topologies allows the monitoring system to correlate anomalies between these different topology sources.

The smart topology correlation may merge topology-based correlation with aggregation rules. The aggregation rules may filter and group by anomaly fields and the monitoring system may integrate topology correlation into the aggregation rules. The monitoring system may correlate on the topology by default and may customize the default behavior using the aggregation rules, explicitly specifying filters, groups of topologies to correlate, and any non-topology-based grouping.

As further shown in FIG. 1E, and by reference number 140, the monitoring system may aggregate the anomalies generated by the customized topology, into events, based on the aggregation rules. For example, when aggregating the anomalies generated by the customized topology into the events, the monitoring system may utilize an aggregation rule to aggregate the anomalies into the events based on topologies associated with the anomalies, may utilize an aggregation rule to aggregate the anomalies into the events based on sources of the anomalies, may utilize an aggregation rule to aggregate the anomalies into the events based on time periods associated with the anomalies, may utilize an aggregation rule to aggregate the anomalies into the events based on a smart topology correlation, and/or the like.

In one example, a plurality of anomalies may be associated with a malfunctioning device of the system and the monitoring system may group the plurality of anomalies into an event identifying the malfunctioning device. In another example, a plurality of anomalies may be associated with several devices of the system and an application executing on the several devices. In such an example, the monitoring system may group the plurality of anomalies into an event identifying the application executing on the several devices.

As shown in FIG. 1F, and by reference number 145, the monitoring system may process the events, with a machine learning model, to generate clustered events from the events. For example, the monitoring system may utilize the machine learning model to cluster the events and recognize similar events based on the configured alerting rules. The clustering of the events may enable the monitoring system to correlate events with known issues and to trigger automated remediation with high confidence. The monitoring system may utilize the clustered events to identify alert events, to prevent an issue from escalating, to automatically fix an issue before the issue becomes worse, and/or the like. The machine learning model may include a custom supervised machine learning model, such as an LSTM model, a convolutional neural network (CNN) model, and/or the like. After an event has been identified and stored, the monitoring system may label the event with an event type. Once a particular quantity of events have been labelled, the monitoring system may train the machine learning model with features extracted from the labelled events and may intelligently label new events. Once trained, the machine learning model may label events with event types that may be utilized to customize alerting. In one example, the machine learning model may classify transient network issues (e.g., events that include collections of transaction failures and timeouts combined with latency spikes) and may provide an indication of the transient network issues, as a low priority alert, directly to a team responsible for the system.

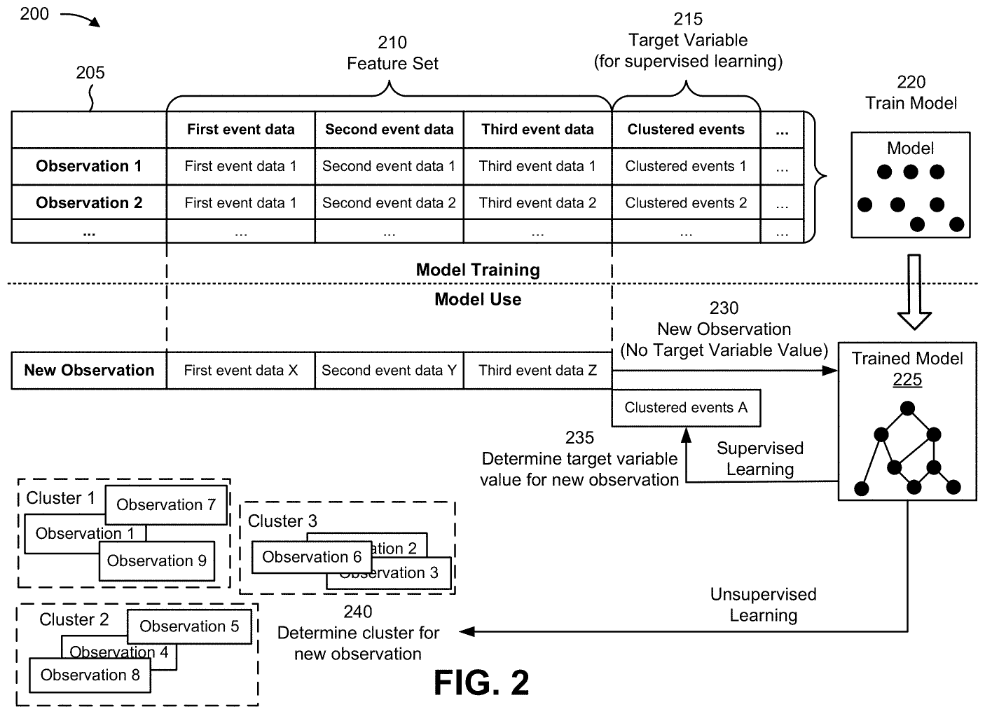

In some implementations, the machine learning model may provide failure and impact prediction based on the clustered events. For example, the machine learning model may cluster time-based event snapshots (e.g., clustering event snapshots one minute, two minutes, five minutes, and/or the like after an event begins). As new events develop, the machine learning model may classify the new events with the clustered event snapshots of a similar age (e.g., when an event is two minutes old, cluster the event with all two minute event snapshots). Once the new event is classified with a group, the machine learning model may utilize end states of the snapshots in that group to predict an end state of the new event. For developing events, the machine learning model may determine a probability of the most likely end states, a predicted time until the most likely end states, and a business impact of the most likely end states. Further details of the machine learning model are provided below in connection with FIG. 2.

In some implementations, the monitoring system may act as a digital twin for a real world system by providing a simulator in which to test different system configurations. This may enable the monitoring system to optimize configuration parameters for flow control and to identify likely points of failure/bottlenecks with a current system setup. The digital twin may be created by adding real-world system configuration parameters to each node (e.g., a maximum concurrency, runtime, allocated resources for cloud hosted functions, and/or the like) and characteristics to each edge (e.g., throughput, latency, error rate, link type, and/or the like). Over time, as more anomalies are monitored in the system, the monitoring system may determine which changes in node parameters are linked to failures in the system and also how the changes impact flow in the edges between nodes. In this way, the monitoring system may simulate changes in the system, which may enable the monitoring system to identify failure points in the system and a deviation from normal behavior, simulate impacts of alternative parameters on the system, recommend changes in a current configuration to improve system performance, and/or the like.

As shown in FIG. 1G, and by reference number 150, the monitoring system may configure alerting rules associated with alerting actions, by mapping the alerting rules with the clustered events, to generate configured alerting rules. For example, when configuring the alerting rules associated with the alerting actions to generate the configured alerting rules, the monitoring system may map the alerting rules with the clustered events to generate the configured alerting rules. The alerting rules may map events that match alerting rules to specific alerting actions. The alerting rules may be based on sizes of the event, severities of the events, to which components of the system the events are associated, and/or the like. In some implementations, each alerting rule may include nestable rule logic identifying metrics to be included for an alert, a severity level for an alert, and/or the like; a mapping to alert actions (e.g., generate a ticket, provide a particular email template to particular users, and/or the like); and/or the like.

In some implementations, to reduce false alerts being generated by the alerting rules, the monitoring system may tighten anomaly detection, may aggregate more anomalies into an event, may cause alerting to be more stringent. The monitoring system may be configured to fit the system being monitored, and may improve performance of the system by immediately raising alerts with default anomaly detection, by preventing excessive alerting, by customizing anomaly detection to increase precision, by relaxing alerting rules to not prevent important alerts, and/or the like. In some implementations, the monitoring system may integrate external alerts (e.g., from third party applications) with the alerts generated based on the alerting rules. In such implementations, the monitoring system may function as both an anomaly detection system and an alert collation system, which may enhance existing monitoring applications.

Due to the aggregation of anomalies, the monitoring system may generate a smaller quantity of detailed alerts when compared to alternative platforms. This may reduce alert fatigue on service desk operators and may improve root cause investigation and resolution and may reduce processing demands as compared to conventional techniques. The monitoring system may monitor base metrics for anomalies, may ingest externally-detected anomalies, and merge the external anomalies into events. This hybrid approach enables the monitoring system to integrate with existing monitoring solutions and to augment the existing monitoring solutions with advanced detection on other metrics, which may improve accuracy and deployment time of the monitoring system. Furthermore, by detecting a wide range of accurate anomalies and correlating them into related events, the monitoring system may generate accurate and significant alerts that provide information associated with root causes. With this approach, responders may react quickly and appropriately to alerts, reducing resolution time.

As further shown in FIG. 1G, and by reference number 155, the monitoring system may perform one or more actions based on the clustered events and the configured alerting rules. In some implementations, performing the one or more actions includes the monitoring system identifying an issue with the system based on the clustered events and preventing the issue from escalating. For example, the monitoring system may determine that the clustered events indicate an issue with a device of the system. Based on this determination, the monitoring system may cause the device to be replaced, corrected, and/or the like, to address the issue. In this way, the monitoring system may conserve computing resources, networking resources, and/or the like that would otherwise have been consumed in failing to provide high level control of the system, failing to determine an impact of a system failure, losing business opportunities with a client due to a failing system, and/or the like.

In some implementations, performing the one or more actions includes the monitoring system identifying an issue with the system based on the clustered events and correcting the issue. For example, the monitoring system may determine that the clustered events indicate an issue with an application of the system. Based on this determination, the monitoring system may cause the application to be replaced, corrected, and/or the like, to address the issue. In this way, the monitoring system may conserve computing resources, networking resources, and/or the like that would otherwise have been consumed in failing to determine an impact of a system failure, coordinating various teams of personnel to monitor the system, losing business opportunities with a client due to a failing system, and/or the like.

In some implementations, performing the one or more actions includes the monitoring system generating one or more alerts based on the clustered events. For example, the monitoring system may determine that the clustered events satisfy a threshold associated with generating an alert. The monitoring system may generate an alert by generating a ticket associated with servicing the system, generating an email configured with information about the clustered events, and/or the like. In this way, the monitoring system may conserve computing resources, networking resources, and/or the like that would otherwise have been consumed in coordinating various teams of personnel to monitor the system, losing business opportunities with a client due to a failing system, and/or the like.

In some implementations, performing the one or more actions includes the monitoring system identifying an issue with the system based on the clustered events and modifying the system to eliminate the issue. For example, the monitoring system may determine that the clustered events indicate an issue with a connection between two devices of the system. Based on this determination, the monitoring system may cause the connection to be replaced to eliminate the issue. In this way, the monitoring system may conserve computing resources, networking resources, and/or the like that would otherwise have been consumed in failing to provide high level control of the system, failing to determine an impact of a system failure, and/or the like.

In some implementations, performing the one or more actions includes the monitoring system identifying an issue with the system based on the clustered events and dispatching a technician or an autonomous vehicle to service the issue. For example, the monitoring system may determine that the clustered events indicate an issue with a hardware component of the system. Based on this determination, the monitoring system may cause a technician or an autonomous vehicle to be dispatched to service the hardware component and correct the issue. In this way, the monitoring system may conserve computing resources, networking resources, and/or the like that would otherwise have been consumed in failing to provide high level control of the system, failing to determine an impact of a system failure, coordinating various teams of personnel to monitor the system, and/or the like.

In some implementations, performing the one or more actions includes the monitoring system retraining the machine learning model based on the clustered events. For example, the monitoring system may utilize the clustered events as additional training data for retraining the machine learning model, thereby increasing the quantity of training data available for training the machine learning model. Accordingly, the monitoring system may conserve computing resources associated with identifying, obtaining, and/or generating historical data for training the machine learning model relative to other systems for identifying, obtaining, and/or generating historical data for training machine learning models.

In this way, the monitoring system utilizes topology-centric monitoring to model a system and correlate low level system anomalies and high level system impacts. The monitoring system may monitor metric data of the system with multiple anomaly detection models, and may represent these metrics in multi-layered system networks. The monitoring system may correlate anomalies into events with network links and defined rules, and may trigger event alerting actions (e.g., alarms, tickets, emails, and/or the like) via rules and/or event clustering. The monitoring system may significantly reduce incident triage time, may resolve issues more quickly, and may reduce an impact of an incident. The incident triage time may be reduced, as compared to conventional techniques, due to the monitoring system identifying anomalies earlier and with higher accuracy, grouping anomalies in accordance with the defined rules, generating visualizations showing the anomalies, linking failures to material system impacts, and/or the like. This, in turn, conserves computing resources, networking resources, and/or the like that would otherwise have been consumed in failing to provide high level control of the system, failing to determine an impact of a system failure, coordinating various teams of personnel to monitor the system, losing business opportunities with a client due to a failing system, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

FIG. 2 is a diagram illustrating an example 200 of training and using a machine learning model in connection with generating clustered events. The machine learning model training and usage described herein may be performed using a machine learning system. The machine learning system may include or may be included in a computing device, a server, a cloud computing environment, and/or the like, such as the monitoring system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the monitoring system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the monitoring system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of first event data, a second feature of second event data, a third feature of third event data, and so on. As shown, for a first observation, the first feature may have a value of first event data 1, the second feature may have a value of second event data 1, the third feature may have a value of third event data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable are clustered events, which has a value of clustered events 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of first event data X, a second feature of second event data Y, a third feature of third event data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of clustered events A for the target variable of the clustered events for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first event data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second event data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate clustered events. The machine learning system enables recognition and/or identification of tens, hundreds, thousands, or millions of features and/or feature values for tens, hundreds, thousands, or millions of observations, thereby increasing accuracy and consistency and reducing delay associated with generating clustered events relative to requiring computing resources to be allocated for tens, hundreds, or thousands of operators to manually generate clustered events.

As indicated above, FIG. 2 is provided as an example. Other examples may differ from what is described in connection with FIG. 2.

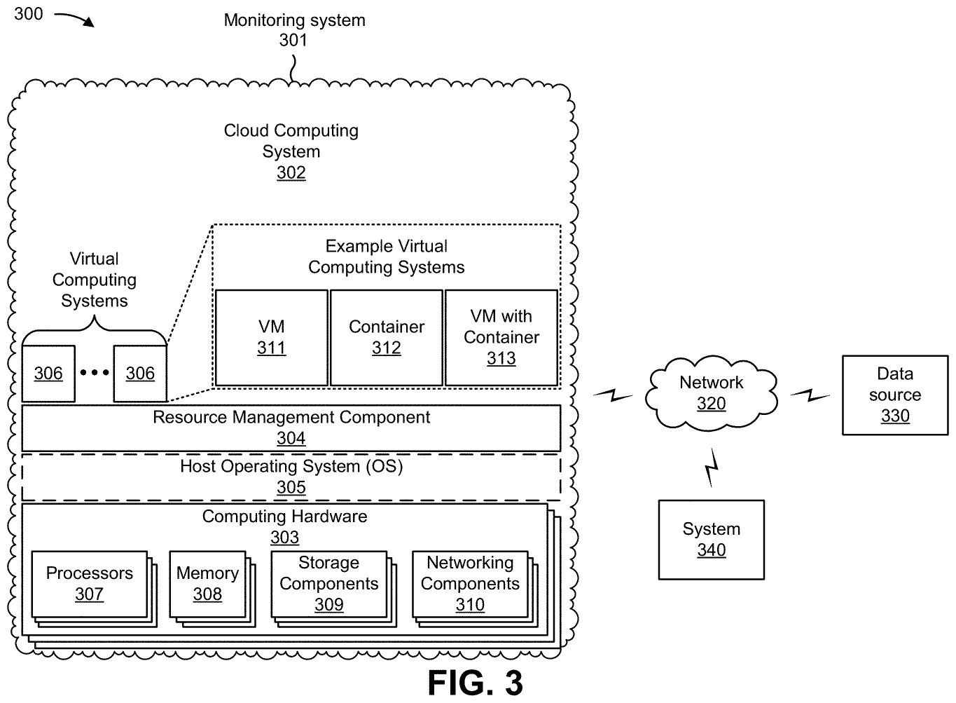

FIG. 3 is a diagram of an example environment 300 in which systems and/or methods described herein may be implemented. As shown in FIG. 3, the environment 300 may include a monitoring system 301, which may include one or more elements of and/or may execute within a cloud computing system 302. The cloud computing system 302 may include one or more elements 303-313, as described in more detail below. As further shown in FIG. 3, the environment 300 may include a network 320, a data source 330, and/or a system 340. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of the computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

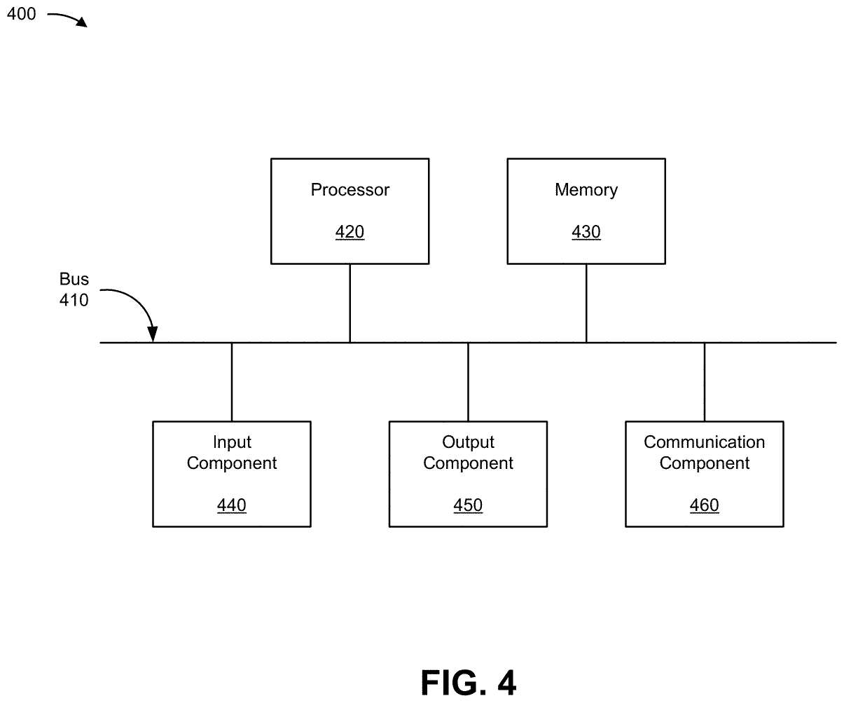

Although the monitoring system 301 may include one or more elements 303-313 of the cloud computing system 302, may execute within the cloud computing system 302, and/or may be hosted within the cloud computing system 302, in some implementations, the monitoring system 301 may not be cloud-based (e.g., may be implemented outside of a cloud computing system) or may be partially cloud-based. For example, the monitoring system 301 may include one or more devices that are not part of the cloud computing system 302, such as device 400 of FIG. 4, which may include a standalone server or another type of computing device. The monitoring system 301 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or the like, and/or a combination of these or other types of networks. The network 320 enables communication among the devices of the environment 300.

The data source 330 includes one or more devices capable of receiving, generating, storing, processing, providing, and/or routing information, as described elsewhere herein. The data source 330 may include a communication device and/or a computing device. For example, the data source 330 may include a server, such as an application server, a client server, a web server, a database server, a host server, a proxy server, a virtual server (e.g., executing on computing hardware), or a server in a cloud computing system. In some implementations, the data source 330 includes computing hardware used in a cloud computing environment.

The system 340 includes one or more devices capable of receiving, generating, storing, processing, providing, and/or routing information, as described elsewhere herein. The system 340 may include a communication device and/or a computing device. For example, the system 340 may include a server, such as an application server, a client server, a web server, a database server, a host server, a proxy server, a virtual server (e.g., executing on computing hardware), or a server in a cloud computing system. In some implementations, the system 340 includes computing hardware used in a cloud computing environment. In some implementations, the system 340 includes an information system, a communications system, a computer system, and/or the like, with a network of devices, applications, hardware, software, peripheral equipment, and/or the like operated by a group of users.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the monitoring system 301, the data source 330, and/or the system 340. In some implementations, the monitoring system 301, the data source 330, and/or the system 340 may include one or more devices 400 and/or one or more components of the device 400. As shown in FIG. 4, the device 400 may include a bus 410, a processor 420, a memory 430, an input component 440, an output component 450, and a communication component 460.

The bus 410 includes a component that enables wired and/or wireless communication among the components of device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The input component 440 enables the device 400 to receive input, such as user input and/or sensed inputs. For example, the input component 440 may include a touch screen, a keyboard, a keypad, a mouse, a button, a microphone, a switch, a sensor, a global positioning system component, an accelerometer, a gyroscope, an actuator, and/or the like. The output component 450 enables the device 400 to provide output, such as via a display, a speaker, and/or one or more light-emitting diodes. The communication component 460 enables the device 400 to communicate with other devices, such as via a wired connection and/or a wireless connection. For example, the communication component 460 may include a receiver, a transmitter, a transceiver, a modem, a network interface card, an antenna, and/or the like.

The device 400 may perform one or more processes described herein. For example, a non-transitory computer-readable medium (e.g., the memory 430) may store a set of instructions (e.g., one or more instructions, code, software code, program code, and/or the like) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

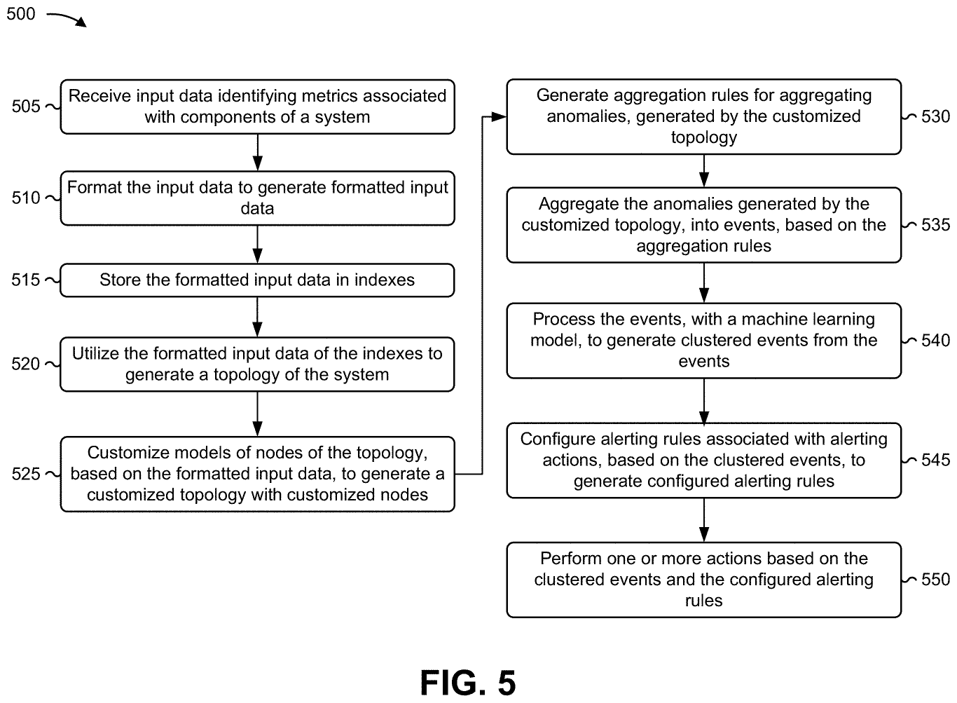

FIG. 5 is a flowchart of an example process 500 for utilizing topology-centric monitoring to model a system and correlate low level system anomalies and high level system impacts. In some implementations, one or more process blocks of FIG. 5 may be performed by a device (e.g., the monitoring system 301). In some implementations, one or more process blocks of FIG. 5 may be performed by another device or a group of devices separate from or including the device, such as a data source (e.g., the data source 330) and/or a system (e.g., the system 340). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving input data identifying metrics associated with components of a system (block 505). For example, the device may receive input data identifying metrics associated with components of a system, as described above. In some implementations, receiving the input data includes causing a global data transform to execute across multiple data sources and to transform the multiple data sources into a single homogenous data source, and receiving the input data from the single homogeneous data source.

As further shown in FIG. 5, process 500 may include formatting the input data to generate formatted input data (block 510). For example, the device may format the input data to generate formatted input data, as described above. In some implementations, formatting the input data to generate the formatted input data includes extracting the metrics from the input data, wherein the metrics correspond to the formatted input data.

As further shown in FIG. 5, process 500 may include storing the formatted input data in indexes (block 515). For example, the device may store the formatted input data in indexes, as described above.

As further shown in FIG. 5, process 500 may include utilizing the formatted input data of the indexes to generate a topology of the system (block 520). For example, the device may utilize the formatted input data of the indexes to generate a topology of the system, as described above. In some implementations, the topology includes nodes and connectors, wherein each node includes a model that processes corresponding formatted input data. In some implementations, each node includes a set of metrics to be processed by the model, the model, and a user interface representation. In some implementations, the model of each node includes one or more of a static thresholding model, a mean absolute deviation model, a mean absolute difference model, a fast Fourier model, an average seasonal model, an independent trend model, a smart seasonal model, or a long short-term memory model.

As further shown in FIG. 5, process 500 may include customizing the models of the nodes of the topology, based on the formatted input data, to generate a customized topology with customized nodes (block 525). For example, the device may customize the models of the nodes of the topology, based on the formatted input data, to generate a customized topology with customized nodes, as described above.

As further shown in FIG. 5, process 500 may include generating aggregation rules for aggregating anomalies, generated by the customized topology (block 530). For example, the device may generate aggregation rules for aggregating anomalies, generated by the customized topology, as described above.

As further shown in FIG. 5, process 500 may include aggregating the anomalies generated by the customized topology, into events, based on the aggregation rules (block 535). For example, the device may aggregate the anomalies generated by the customized topology, into events, based on the aggregation rules, as described above. In some implementations, aggregating the anomalies generated by the customized topology, into the events, based on the aggregation rules includes one or more of aggregating the anomalies into the events based on topologies associated with the anomalies, aggregating the anomalies into the events based on sources of the anomalies, or aggregating the anomalies into the events based on time periods associated with the anomalies. In some implementations, aggregating the anomalies generated by the customized topology, into the events, based on the aggregation rules includes aggregating the anomalies generated by the customized topology, into the events, based on a smart topology correlation.

As further shown in FIG. 5, process 500 may include processing the events, with a machine learning model, to generate clustered events from the events (block 540). For example, the device may process the events, with a machine learning model, to generate clustered events from the events, as described above. In some implementations, the machine learning model includes a long short-term memory model and/or a convolutional neural network model.

As further shown in FIG. 5, process 500 may include configuring alerting rules associated with alerting actions, based on the clustered events, to generate configured alerting rules (block 545). For example, the device may configure alerting rules associated with alerting actions, based on the clustered events, to generate configured alerting rules, as described above. In some implementations, configuring the alerting rules associated with the alerting actions, based on the clustered events, to generate the configured alerting rules includes mapping the alerting rules with the clustered events to generate the configured alerting rules.

As further shown in FIG. 5, process 500 may include performing one or more actions based on the clustered events and the configured alerting rules (block 550). For example, the device may perform one or more actions based on the clustered events and the configured alerting rules, as described above. In some implementations, performing the one or more actions includes one or more of generating one or more alerts based on the clustered events and based on the configured alerting rules, identifying an issue with the system based on the clustered events and preventing the issue from escalating, or identifying an issue with the system based on the clustered events and correcting the issue.

In some implementations, performing the one or more actions includes one or more of identifying an issue with the system based on the clustered events and modifying the system to eliminate the issue, identifying an issue with the system based on the clustered events and dispatching a technician or an autonomous vehicle to service the issue, or retraining the machine learning model based on the clustered events. In some implementations, performing the one or more actions includes generating an alert based on the clustered events and based on the configured alerting rules, receiving feedback associated with the alert, and modifying the system based on the feedback.

In some implementations, process 500 includes associating a prediction model with one or more nodes of the topology.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, input data identifying metrics associated with components of a system;
formatting, by the device, the input data to generate formatted input data;
storing, by the device, the formatted input data in indexes;
utilizing, by the device, the formatted input data of the indexes to generate a topology of the system,
wherein the topology includes nodes and connectors,
wherein each node includes a model that processes corresponding formatted input data;
customizing, by the device, the models of the nodes of the topology, based on the formatted input data, to generate a customized topology with customized nodes;
generating, by the device, aggregation rules for aggregating anomalies, generated by the customized topology;
aggregating, by the device, the anomalies generated by the customized topology, into events, based on the aggregation rules;
processing, by the device, the events, with a machine learning model, to generate clustered events from the events;
configuring, by the device, alerting rules associated with alerting actions, based on the clustered events, to generate configured alerting rules; and
performing, by the device, one or more actions based on the clustered events and the configured alerting rules.

2. The method of claim 1, wherein receiving the input data comprises:
causing a global data transform to execute across multiple data sources and to transform the multiple data sources into a single homogenous data source; and
receiving the input data from the single homogeneous data source.

3. The method of claim 1, further comprising:
associating a prediction model with one or more nodes of the topology.

4. The method of claim 1, wherein configuring the alerting rules associated with the alerting actions, based on the clustered events, to generate the configured alerting rules comprises:
mapping the alerting rules with the clustered events to generate the configured alerting rules.

5. The method of claim 1, wherein formatting the input data to generate the formatted input data comprises:
extracting the metrics from the input data,
wherein the metrics correspond to the formatted input data.

6. The method of claim 1, wherein aggregating the anomalies generated by the customized topology, into the events, based on the aggregation rules comprises one or more of:
aggregating the anomalies into the events based on topologies associated with the anomalies;
aggregating the anomalies into the events based on sources of the anomalies; or
aggregating the anomalies into the events based on time periods associated with the anomalies.

7. The method of claim 1, wherein the machine learning model includes a long short-term memory model and/or a convolutional neural network model.

8. A device, comprising:
one or more memories; and
one or more processors, coupled to the one or more memories, configured to:
cause a global data transform to execute across multiple data sources and to transform the multiple data sources into a single homogenous data source;
receive, from the single homogeneous data source, input data identifying metrics associated with components of a system;
format the input data to generate formatted input data;
store the formatted input data in a data structure;
utilize the formatted input data of the data structure to generate a topology of the system,
wherein the topology includes nodes and connectors,
wherein each node includes a model that processes corresponding formatted input data;
customize the models of the nodes of the topology, based on the formatted input data, to generate a customized topology with customized nodes;
generate aggregation rules for aggregating anomalies, generated by the customized topology;
aggregate the anomalies generated by the customized topology, into events, based on the aggregation rules;
process the events, with a machine learning model, to generate clustered events from the events;
configure alerting rules associated with alerting actions, based on the clustered events, to generate configured alerting rules; and
perform one or more actions based on the clustered events and the configured alerting rules.

9. The device of claim 8, wherein each node includes:
a set of metrics to be processed by the model,
the model, and
a user interface representation.

10. The device of claim 8, wherein the model of each node includes one or more of:
a static thresholding model,
a mean absolute deviation model,
a mean absolute difference model,
a fast Fourier model,
an average seasonal model,
an independent trend model,
a smart seasonal model, or
a long short-term memory model.

11. The device of claim 8, wherein the one or more processors, to aggregate the anomalies generated by the customized topology, into the events, based on the aggregation rules, are configured to:
aggregate the anomalies generated by the customized topology, into the events, based on a smart topology correlation.

12. The device of claim 8, wherein the one or more processors, to perform the one or more actions, are configured to one or more of:
generate one or more alerts based on the clustered events and based on the configured alerting rules;
identify an issue with the system based on the clustered events and preventing the issue from escalating; or
identify an issue with the system based on the clustered events and correcting the issue.

13. The device of claim 8, wherein the one or more processors, to perform the one or more actions, are configured to one or more of:
identify an issue with the system based on the clustered events and modifying the system to eliminate the issue;
identify an issue with the system based on the clustered events and dispatching a technician or an autonomous vehicle to service the issue; or
retrain the machine learning model based on the clustered events.

14. The device of claim 8, wherein the one or more processors, to perform the one or more actions, are configured to:
generate an alert based on the clustered events and based on the configured alerting rules;
receive feedback associated with the alert; and
modify the system based on the feedback.

15. A non-transitory computer-readable medium storing a set of instructions, the set of instructions comprising:
one or more instructions that, when executed by one or more processors of a device, cause the device to:
receive input data identifying metrics associated with components of a system;
format the input data to generate formatted input data;
utilize the formatted input data to generate a topology of the system,
wherein the topology includes nodes and connectors,
wherein each node includes a model that processes corresponding formatted input data;
customize the models of the nodes of the topology, based on the formatted input data, to generate a customized topology with customized nodes;
generate aggregation rules for aggregating anomalies, generated by the customized topology;
aggregate the anomalies generated by the customized topology, into events, based on the aggregation rules;
process the events, with a machine learning model, to generate clustered events from the events;
configure alerting rules associated with alerting actions, based on the clustered events, to generate configured alerting rules; and
perform one or more actions based on the clustered events and the configured alerting rules.

16. The non-transitory computer-readable medium of claim 15, wherein the one or more instructions further cause the device to:
associate a prediction model with one or more nodes of the topology.

17. The non-transitory computer-readable medium of claim 15, wherein the one or more instructions, that cause the device to configure the alerting rules associated with the alerting actions to generate the configured alerting rules, cause the device to:
map the alerting rules with the clustered events to generate the configured alerting rules.

18. The non-transitory computer-readable medium of claim 15, wherein the one or more instructions, that cause the device to aggregate the anomalies generated by the customized topology, into the events, based on the aggregation rules, cause the device to one or more of:
aggregate the anomalies into the events based on topologies associated with the anomalies;
aggregate the anomalies into the events based on sources of the anomalies; or
aggregate the anomalies into the events based on time periods associated with the anomalies.

19. The non-transitory computer-readable medium of claim 15, wherein the one or more instructions, that cause the device to aggregate the anomalies generated by the customized topology, into the events, based on the aggregation rules, cause the device to:
aggregate the anomalies generated by the customized topology, into the events, based on a smart topology correlation.

20. The non-transitory computer-readable medium of claim 15, wherein the one or more instructions, that cause the device to perform the one or more actions, cause the device to one or more of:
generate one or more alerts based on the clustered events and based on the configured alerting rules;
identify an issue with the system based on the clustered events and preventing the issue from escalating;
identify an issue with the system based on the clustered events and correcting the issue;
identify an issue with the system based on the clustered events and modifying the system to eliminate the issue;
identify an issue with the system based on the clustered events and dispatching a technician or an autonomous vehicle to service the issue; or
retrain the machine learning model based on the clustered events.
